(19) United States
(12) Patent Application Publication
(10) Pub. No.: US 2025/0362129 A1
(43) Pub. Date: Nov. 27, 2025

(54) MICROELECTROMECHANICAL COUPLING DEVICE

(71) Applicant: Northrop Grumman Litef GmbH, Freiburg (DE)

(72) Inventor: Jan Daniel RENDE, Freisen (DE)

(21) Appl. No.: 18/872,337

(22) PCT Filed: May 15, 2023
(86) PCT No.: PCT/EP2023/062947

§ 371 Date: Dec. 6, 2024

(30) Foreign Application Priority Data
Jun. 8, 2022 (DE) 10 2022 114 406.2

(51) Int. Cl. G01C 19/5712

(52) U.S. Cl. CPC G01C 19/5712

(57) ABSTRACT

The invention relates to a microelectromechanical coupling device (100) for coupling microelectromechanical components, having a flexible ring structure (110) which forms a circle in an idle state and which can be deformed substantially parallel to the plane of the circle and is suitable for coupling the microelectromechanical components (200); and a plurality of spring elements (120) which are suitable for connecting the ring structure (110) to a substrate. The coupling device (100) has such a large number of a spring elements (120), such a small width in the circumferential direction of the ring structure (110), and such a low spring hardness that the deformability of the ring structure (110) is homogenous in the circumferential direction of the ring structure (110).

The present invention relates to a microelectromechanical coupling device for coupling microelectromechanical components and to a microelectromechanical measuring device, in particular, an annular microelectromechanical angular rate sensor that includes the coupling device.

In micromechanical measuring devices such as angular rate or acceleration sensors, different micromechanical components, such as oscillation systems or masses, often have to be connected to each other in order to couple the respective movements.

Coupling by a free-floating, non-mounted ring would often be desirable in this case, since such a ring reacts to a radial force effect with a deflection that, regardless of the point in a circumferential direction to which the radial force effect is applied, has the same amplitude. Similarly, it can be advantageous to use a free-floating ring as an angular rate sensor, in which an excitation oscillation is superimposed with a detection oscillation due to the Coriolis force during rotation.

The problem here, however, is that without any connection to a substrate of the measuring device, translational modes form the first eigenmodes. However, these are often not desirable. Moreover, the manufacture of a non-mounted ring for coupling microelectromechanical components involves a great deal of effort in terms of manufacturing technology.

A well-known example of this is the use of stiff, short connections (so-called spokes), which are very space-saving but do not allow resonances in the range of a few kHz due to their stiffness. In addition, homogeneous behavior in a circumferential direction cannot be achieved with this design.

Alternatively, extremely long and therefore space-consuming, but also very soft springs are used. Although low resonance frequencies can be achieved with these, the deviations from the ideal ring are also very large in this case, as no homogeneous behavior can be achieved in a circumferential direction.

The aim is therefore to achieve the most homogeneous mounting possible for the ring structure, with which the perfect symmetry of the ring structure is influenced as little as possible. This could be achieved by completely omitting the mounting, but this is very difficult to implement. Alternatively, when many springs are used that are distributed around the circumference, the springs must not be too stiff, as otherwise they would influence the ring locally too much and increase the natural frequencies of the overall system. There is therefore a conflict of objectives to provide a coupling that is as soft as possible, but at the same time does not require too much installation space.

The present invention is thus based on the object of specifying a microelectromechanical coupling device and an annular microelectromechanical angular rate sensor which achieve the above-mentioned advantages of a free-floating, non-mounted ring, without causing the above-mentioned disadvantages.

This object is achieved by the subject matter of claim 1.

A microelectromechanical coupling device for coupling microelectromechanical components has a flexible ring structure, which forms a circle at rest, which can be deformed substantially parallel to the plane of the circle, and which is suitable for coupling the microelectromechanical components. Moreover, the coupling device includes a plurality of spring elements which are suitable for connecting the ring structure to a substrate, wherein the coupling device includes such a large number of spring elements with such a small width in a circumferential direction of the ring structure and such a low spring hardness that the deformability of the ring structure in a circumferential direction of the ring structure is homogeneous.

The coupling device therefore has a ring as its basic structure, which is mounted above a substrate and, for example, has the shape of a self-contained bar, the height of which perpendicular to the substrate is many times its width parallel to the substrate. In the rest position, this ring forms a circle in the broadest sense, i.e., a closed curve that is parallel to the substrate. A deformation of the ring is then substantially only possible parallel to the substrate, i.e., deflections perpendicular to the substrate are negligible for the operation.

In order to suppress the translational modes, the ring structure is connected to the substrate via a large number of spring elements, where the connection to the substrate does not have to be direct, i.e., additional elements can be interposed between the substrate and the spring elements. The large number of spring elements guarantees that the ring structure is coupled to the substrate at many points along the circumferential direction. For this purpose, the spring elements must be designed sufficiently narrow in a circumferential direction of the ring structure so that there is no interference between their respective movements among each other. Finally, the spring hardness of each of the spring elements must also be sufficiently low so as not to excessively restrict the desired free deformability of the ring structure.

The parameters of the number of spring elements, their width in a circumferential direction and their spring hardness are interdependent. For example, when very soft spring elements are used, the number of spring elements can be reduced and their width increased. When harder spring elements are used, the number can be increased or the width reduced.

Therefore, there is a multitude of possibilities for specifying the parameters of the spring elements. However, the only decisive factor here is that the selected parameters only restrict the deformability of the ring structure to the extent that the ring structure retains its homogeneous spring characteristics in a circumferential direction. The ring structure must therefore be coupled to the substrate by the spring elements in such a way that it reacts to a radial force effect with a deflection that has the same amplitude/deformation (in a first approximation) at every point in a circumferential direction to which the radial force effect is applied. The overall system of spring elements and ring structure must therefore react (in a first approximation) like a translationally fixed but otherwise free-floating ring when excited from outside, in particular, by coupled microelectromechanical components. The overall system of ring structure and spring elements thus looks from the outside like a free-floating ring, with spring hardness displaced relative to the ring structure.

This makes it possible to achieve coupling devices that look like free-floating rings from the outside, but have suppressed translational modes due to the reconnection to the substrate. In addition, the large number of spring elements allows a sufficiently soft coupling to achieve excitation modes in the kHz range as well, which are of particular interest for microelectromechanical measuring devices, especially for annular angular rate sensors.

The term coupling device is to be understood broadly here and is meant to include the coupling or connection of various microelectromechanical components such as masses, springs, oscillation systems or electrodes. The coupling device, in particular, can be the oscillation system of an annular angular rate sensor. The microelectromechanical components are then coupled to the ring structure in order to cause or measure excitation or detection oscillations of the ring structure. In this case, however, the microelectromechanical components can also merely be connections to the substrate, such as the spring elements.

The ratio of the effective overall stiffness of the spring elements during operation of the coupling device in an oscillation mode to the product from the number of spring elements and the effective stiffness of the ring structure in the corresponding oscillation mode can preferably be less than or equal to 1. The effective overall stiffness of the spring elements indicates in this case how the spring elements react all in all to deflections/oscillations of the ring and thus takes into account the fact that different springs are deflected in different ways during oscillation, in particular, in different directions, and therefore each by itself contributes with a different spring stiffness. The same is true for the spring stiffness of the ring structure, which is therefore also taken into account in the comparison as the effective stiffness, i.e., the stiffness that can actually be measured in a specific case. If, for example, 20 springs are present and the effective stiffness of the ring structure is approx. 15 N/m, this results in an upper limit of 300 N/m for the effective overall stiffness of all springs in the corresponding oscillation mode. For 40 springs and an effective stiffness of the ring structure of approx. 30 N/m, an upper limit of 1200 N/m for the effective total stiffness of all springs emerges accordingly.

The spring elements can either all be connected to an inner side of the ring structure or all to an outer side of the ring structure. The coupling of the ring structure can therefore be flexibly guided inwards or outwards from the ring structure, depending on the use of the ring structure. If all spring elements only act on one side of the ring structure, this enables a force and torque-free coupling of microelectromechanical components via the ring structure.

The spring elements can be designed as serpentine springs, i.e., the spring elements consist of a plurality of bending beam springs that extend along the circumferential direction of the ring structure and are connected alternately to each other at their ends, so that a serpentine shape or a zigzag line is created. Such springs can be designed in a compact manner both in a circumferential direction and in a radial direction and nevertheless have a low spring hardness, which leads to resonance frequencies of the coupling device in the kHz range. They are therefore particularly suited for coupling the ring structure to the substrate. The serpentine springs can have between 5 and 50 bending beam springs running in a circumferential direction, e.g., 10, 20 or 30.

The spring elements can be evenly distributed along the circumferential direction of the ring structure. This makes production easier, as all spring elements can then be designed in the same way for the homogeneous deformability of the ring structure, i.e., they have the same spring hardness.

The number of spring elements can be greater than or equal to 4, 8, 16 or 30, preferably greater than or equal to 40, more preferably greater than or equal to 50. This ensures that there is a sufficiently high density of spring elements along the circumferential direction. This improves the homogeneity of the deformability of the ring structure.

The width of the spring elements in a circumferential direction can be less than or equal to ¼, ⅛, 1/16 or 1/30, preferably less than or equal to 1/40, more preferably less than or equal to 1/50 of the circumference of the ring structure. The spring elements are then sufficiently narrow to be coupled to the ring structure at a large number of positions along the circumference of the ring structure.

The spring elements can extend along a radial direction of the ring structure over less than ½ or ¼, preferably over less than ⅕, more preferably over less than ⅛ of the radius of the ring structure at rest. This allows to design the coupling device in a compact manner, as the spring elements also take up little space in a radial direction.

The coupling device can further have a second ring structure, wherein the plurality of spring elements is connected to the ring structure and to the second ring structure, and the ring structure is connected to the substrate via the second ring structure, which, in turn, is preferably connected to the substrate by additional spring elements. The spring elements therefore couple two ring structures together. Further similar spring elements can then be coupled to the second ring structure. However, other microelectromechanical components or spring elements can also be used to connect the second ring structure to the substrate. It is also conceivable to stagger a plurality of ring structures connected by means of soft spring elements. This increases the flexibility in the design of the coupling device and in the design of any measuring devices containing the coupling device.

A microelectromechanical measuring device includes a microelectromechanical coupling device as described above and the microelectromechanical components that are connected to the coupling device. This makes the advantages that can be achieved by the coupling device available for microelectromechanical measuring devices.

An annular microelectromechanical angular rate sensor includes a microelectromechanical coupling device as described above, wherein the ring structure is suitable for producing an excitation oscillation, said excitation oscillation being superimposed with a detection oscillation generated by the Coriolis force during a rotation of the ring structure. In this process, the spring elements can constitute the microelectromechanical components.

The invention will be further described in the following text, with reference to the figures. The figures and their description are purely exemplary. The present invention is defined solely by the subject matter of the claims.

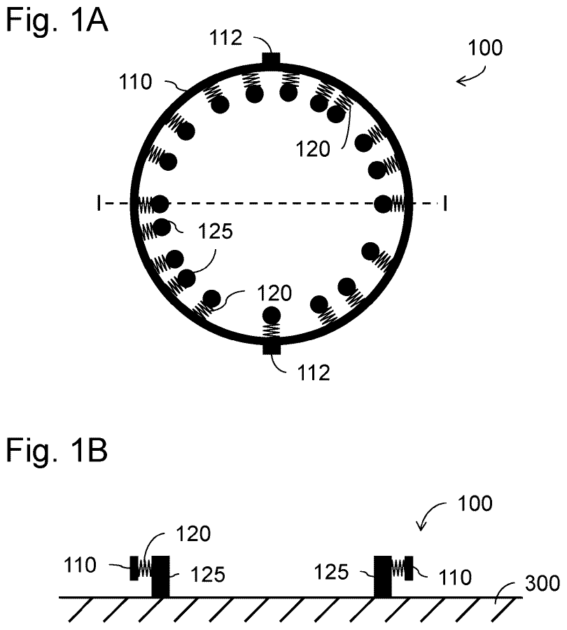

FIGS. 1A and 1B each show a schematic representation of a microelectromechanical coupling device;

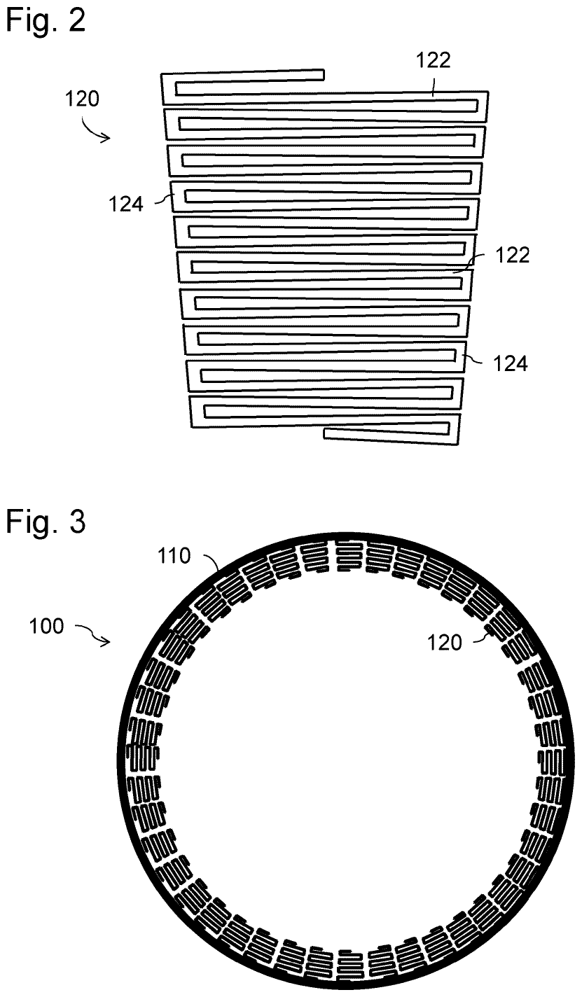

FIG. 2 shows a schematic representation of a spring element designed as a serpentine spring;

FIG. 3 shows a schematic representation of another coupling device;

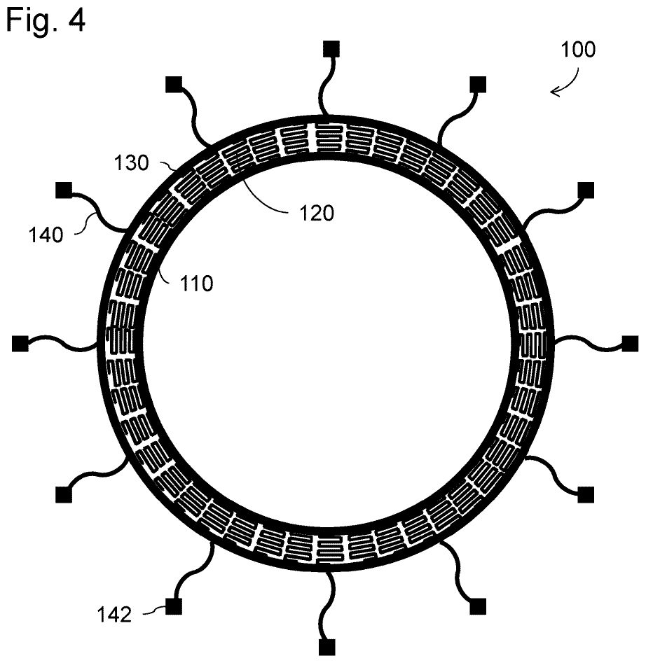

FIG. 4 shows a schematic representation of another coupling device; and

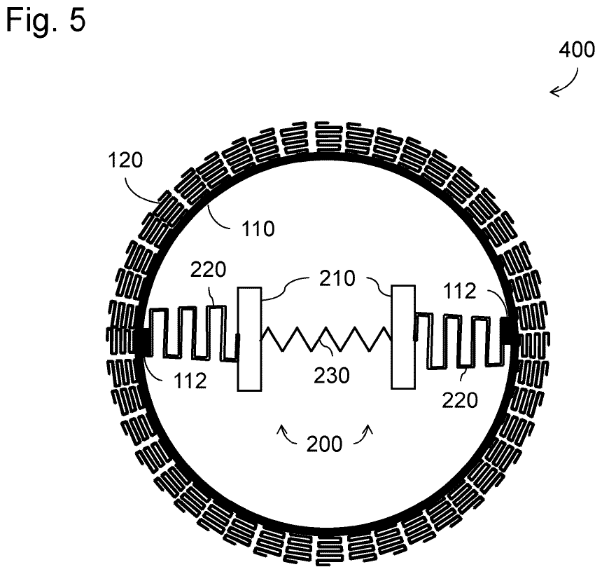

FIG. 5 shows a schematic representation of a microelectromechanical measuring device.

FIGS. 1A and 1B each show a schematic representation of a microelectromechanical coupling device 100, which is suitable for coupling microelectromechanical components 200, such as those used in microelectromechanical measuring devices, such as angular rate and/or acceleration sensors. The microelectromechanical coupling device 100 can also form the basic structure of an annular angular rate sensor. FIG. 1B is a section through FIG. 1A along the line I-I.

The coupling device 100 has a flexible ring structure 110 and a plurality of spring elements 120. As depicted in FIG. 1A, the ring structure forms a circle at rest and can be deformed substantially parallel to the plane of the circle. As can be seen in FIG. 1B, the ring structure 110 has a substantially rectangular cross section perpendicular to the plane of the circle or perpendicular to a substrate 300 above which the ring structure 110 is mounted, with longitudinal sides perpendicular to the substrate 300 that are many times longer than the short sides parallel to the substrate 300. The ring structure 110, for example, can thus be regarded as a self-contained bending beam spring which can deform parallel to the substrate 300, where deformations perpendicular to the substrate 300 (in a first approximation) are negligible. The shape of the ring structure 110 depicted is purely exemplary. The ring structure 110 can have any shape that favors deformation substantially only parallel to the substrate plane. The ring structure 110 can also have a degenerate circular shape in the rest position and, for example, be designed as an ellipse or as a polygon with rounded corners. Such degenerate circular shapes are therefore meant to be also covered by the reference to the circular ring structure 110.

Coupling points 112 are indicated on the ring structure 110, on which the microelectromechanical components 200 to be coupled act or on which these components 200 are connected to the ring structure 110. By means of the coupling, movements between the microelectromechanical components 200 can be transmitted or coordinated. In particular, the coupling device can mediate a force and torque-free push-pull oscillation between the components 200. The microelectromechanical components 200 can be sensor masses or oscillation systems, for example. In principle, however, the type, structure and size of the components 200 to be coupled is arbitrary. The number of components 200 can also be greater than two.

The coupling can also be effected via the spring elements 120. Then the coupling points 112 are missing. In particular, if the coupling device 100 is part of an annular microelectromechanical angular rate sensor, the spring elements 120 can constitute the microelectromechanical components. The ring structure is suitable for producing an excitation oscillation, said excitation oscillation being superimposed with a detection oscillation generated by the Coriolis force during a rotation of the ring structure.

The ring structure is connected to the substrate 300 via a plurality of spring elements 120. The spring elements 120 act on various points of the ring structure 110 and hold it above the substrate 300. As depicted in FIGS. 1A and 1B, the spring elements 120 can be connected to anchor structures 125 and thus connect the ring structure 110 directly to the substrate 300. The anchor structures 125 can have any shape as long as they allow a fixed connection to the substrate 300.

The coupling device 100 has a sufficiently large number of spring elements 120 with such a small width in a circumferential direction of the ring structure 110 and such a low spring hardness that the deformability of the ring structure 110 in a circumferential direction of the ring structure 110 is homogeneous and the coupling device 100 has resonance frequencies in the kHz range. In particular, the width and number of the spring elements 120 can be aligned in such a way that the spring elements 120 are as close to each other as possible, without restricting the desired mobility of the spring elements 120. On the other hand, when the spring hardness of the spring elements 120 is sufficiently low, a greater distance or wider spring elements 120 can also be sufficient for a homogeneous deformability of the ring structure.

For example, the number of spring elements 120 can be greater than or equal to 4, 8, 16, 30, greater than or equal to 40, or greater than or equal to 50. Corresponding to or independent of their number, the width of the spring elements 120 can be less than or equal to ¼, ⅛, 1/16, 1/30, less than or equal to 1/40, or less than or equal to 1/50 of the circumference of the ring structure 110.

The large number of points of action of spring elements 120 on the ring structure 110 ensures that the response to force effects on the ring structure 110 is with a spring hardness which results from the spring hardness of the ring structure 110 and the spring hardnesses of the spring elements 120 deformed by the force effect, with the total spring hardness being substantially the same in a circumferential direction. The coupling device 100 thus reacts in the same way to force effects from any direction, i.e., it has a homogeneous deformability. The entire coupling device 100 therefore reacts to external stimuli like a translationally fixed, but otherwise free-floating ring.

As depicted in FIG. 1A, all spring elements 120 can be connected to an inner side of the ring structure 110. However, the spring elements 120 can also be connected to an outer side of the ring structure 110, as, for example, depicted in FIGS. 4 and 5. By arranging all the spring elements 120 outside or inside the ring structure 110, it can be ensured that the microelectromechanical components 200 (with appropriate selection of the position of the coupling points 112) can be coupled free of forces and torques. In principle, however, the spring elements 120 can also act on the ring structure 110 from both sides.

As depicted in FIGS. 3 to 5, the spring elements 120 can be evenly distributed along the circumferential direction of the ring structure 110. This simplifies the manufacture of the coupling device 100, since all spring elements 120 can be manufactured in the same way. The resulting equal spring hardness of the spring elements 120, in combination with the even distribution along the circumference of the ring structure 110, guarantees that a force effect on the coupling device 100 produces the same counterforce at all points of the coupling device 100.

As depicted in FIG. 1A, the spring elements 120 can also be unevenly distributed along the circumferential direction of the ring structure 110. In this case, the spring hardnesses of the various spring elements 120 must vary in such a way that a homogeneous deformability of the ring structure 110 can nevertheless be achieved as a result. For example, the spring elements 120 can have lower spring hardnesses in areas with a higher density of spring elements 120 than in areas with a low density of spring elements 120.

In addition to limiting the width of the spring elements 120 along the circumferential direction, it is also advisable to limit the length of the spring elements 120 along a radial direction of the ring structure 110 to less than ½, less than ¼, less than ⅕, less than ⅙, less than ⅛ or to 1/10 of the radius of the ring structure 110 at rest. As a result, more compact microelectromechanical structures can be achieved, since the interior space of the coupling device 100 can also be used for the arrangement of microelectromechanical components 200, as, for example, depicted in FIG. 5.

The spring elements 120 are depicted completely schematically in FIGS. 1A and 1B by spiral spring symbols. However, the spring elements 120 can have any shape as long as a sufficiently low spring hardness can be achieved.

The design of the spring elements 120 as serpentine springs, for example, has proven to be particularly advantageous. An example of a serpentine spring is depicted schematically in FIG. 2. The serpentine spring has a plurality of transverse springs 122 which, for example, are formed by bending beam springs whose main direction of deflection is parallel to the substrate 300. The transverse springs 122 are connected alternately at their ends to spring bars 124 in such a way that a serpentine-shaped spring is formed. The spring bars 124 can also be greatly shortened or omitted, so that essentially a zigzag line is formed. FIG. 2 only depicts the fundamental basic structure. The individual elements of the serpentine spring can also be designed differently. For example, the transverse springs 122 can also be designed as a series of circular arcs, in particular, concentric circles. Also, the spring bars 124 or generally the connections between the transverse springs 124 need not be arranged in alignment, but can also be offset relative to one another. The serpentine spring is essentially a multi-bent or kinked bending beam spring in a meander shape.

Due to this structure, the serpentine spring is soft with respect to deflections in the plane of the meanders (image plane of FIG. 2), but relatively hard with respect to deflections perpendicular thereto (perpendicular to the image plane of FIG. 2). The spring retains this property even with a narrow structure, i.e., if, with a minimum length of the spring bars 124 that is required to connect the transverse springs 122, the transverse springs 122 are no longer than 30 times, 20 times or 10 times the length of the spring bars 124. Accordingly, serpentine springs are suitable as spring elements 120 for the coupling device 100.

An example of such a coupling device 100, which, for example, can constitute the basic structure for an annular microelectric angular rate sensor, is depicted in FIG. 3. The coupling device, by way of example, includes 44 spring elements 120 designed as serpentine springs, which act on the inner side of the ring structure 110 at regular intervals. The width of the spring elements 120 is slightly less than 1/44 of the inner circumference of the ring structure 110, so that no gap remains between the individual spring elements 120.

Another example of a coupling device 100 is depicted in FIG. 4. Here, in addition to the ring structure 110 and the spring elements 120 (here acting on the outside of the ring structure 110) (depicted here as serpentine springs by way of example), the coupling device 100 has a second ring structure 130. It is connected to the (first) ring structure 110 via the plurality of spring elements 120. The first ring structure 110 is connected to the substrate 300 via the second ring structure 130.

This structure offers more flexibility with regard to the areas of application of the coupling device 100. In particular, the coupling device 100 can also be used in measuring devices that do not permit direct anchoring of the spring elements 120. Furthermore, the combination with one or more additional ring structures 130 can influence the oscillation behavior of the ring structure 110, e.g., by suppressing certain oscillation modes, or increase the flexibility, in particular, in a circumferential direction. The anchoring of the additional ring structure(s) 130 can be produced via any connections. FIG. 4 exemplifies the connection via, e.g., spoke-like springs 140 and anchor blocks 142. However, any other form of anchoring to the substrate is also conceivable, e.g., via serpentine springs or also via multi-stage or more complex microelectromechanical components, such as oscillation systems, masses, drive and readout electrodes or the like.

FIG. 5 depicts schematically a microelectromechanical measuring device 400 in which a microelectromechanical coupling device 100 is used, as described above.

In addition to the ring structure 110 and the spring elements (depicted therein as serpentine springs by way of example and without anchoring in the substrate) acting on the outside of the ring structure 110, the measuring device includes two oscillation systems as microelectromechanical components 200 that are connected to the coupling device 100 via the coupling points 112. The microelectromechanical components 200, for example, each have a mass 210 and a spring structure 220 that connects the mass 210 to the ring structure 110 of the coupling device 100. In addition, another coupling 230 between the masses 210 is depicted by way of example. As can be seen in FIG. 5, the interior of the coupling device 100 can be used for the arrangement of the microelectromechanical components 200, which allows a compact design of the measuring device 400.

It goes without saying that the microelectromechanical components 200 can also be arranged on the outside when the spring elements 120 are arranged on the inside. In addition, when the coupling points 112 are correspondingly narrow, the spring elements 120 and the microelectromechanical components 200 can also be arranged on the same side of the ring structure 110.

The designs of the ring structure 110 and spring elements 120 described above ensure that the microelectromechanical components 200 can be coupled to each other optimally. This ultimately increases the precision and thus the reliability of the measuring device 400.

In addition, all the coupling devices discussed above can be used as basic components for annular microelectromechanical angular rate sensors in which the ring structure produces the oscillations required for the angular rate detection.

1.-11. (canceled)

12. A microelectromechanical coupling device for coupling microelectromechanical components, comprising:
a flexible ring structure which forms a circle at rest, which can be deformed substantially parallel to the plane of the circle and which is suitable for coupling the microelectromechanical components; and
a plurality of spring elements which are suitable for connecting the ring structure to a substrate; wherein
the coupling device has such a large number of spring elements with such a width in a circumferential direction of the ring structure and such a spring hardness that the deformability of the ring structure is homogeneous in a circumferential direction of the ring structure; and
the ratio of an effective overall stiffness of the spring elements during operation of the coupling device in an oscillation mode to the product from a number of spring elements and an effective stiffness of the ring structure in the corresponding oscillation mode is less than or equal to 1.

13. The coupling device according to claim 12, wherein
either all the spring elements are connected to an inner side of the ring structure or all the spring elements are connected to an outer side of the ring structure.

14. The coupling device according to claim 12, wherein the spring elements are designed as serpentine springs.

15. The coupling device according to claim 12, wherein
the spring elements are evenly distributed along the circumferential direction of the ring structure.

16. The coupling device according to claim 12, wherein
the number of spring elements is greater than or equal to 4, preferably greater than or equal to 8, more preferably greater than or equal to 16.

17. The coupling device according to claim 12, wherein
the width of the spring elements in circumferential direction is less than or equal to ¼, preferably less than or equal to ⅛, more preferably less than or equal to 1/16 of the circumference of the ring structure.

18. The coupling device according to claim 12, wherein
the spring elements extend along a radial direction of the ring structure over less than ½ or ¼, preferably over less than ⅕, more preferably over less than ⅛ of the radius of the ring structure at rest.

19. The coupling device according to claim 12, further comprising:
a second ring structure, wherein
the plurality of spring elements is connected to the ring structure and to the second ring structure, and the ring structure is connected to the substrate via the second ring structure, which, in turn, is preferably connected to the substrate by additional spring elements.

20. A microelectromechanical measuring device, comprising:
the microelectromechanical coupling device according to claim 12; and
the microelectromechanical components that are connected to the coupling device.

21. An annular microelectromechanical angular rate sensor, comprising:
the microelectromechanical coupling device according to claim 12; wherein
the ring structure is suitable for producing an excitation oscillation, said excitation oscillation being superimposed with a detection oscillation generated by the Coriolis force during a rotation of the ring structure; and
the spring elements constitute the microelectromechanical components.
